(19) United States
(12) Patent Application Publication
(10) Pub. No.: US 2024/0204903 A1
(43) Pub. Date: Jun. 20, 2024

(54) OPTICAL TRANSMISSION DEVICE, OPTICAL TRANSMISSION SYSTEM, AND OPTICAL TRANSMISSION METHOD

(71) Applicant: NEC Corporation, Tokyo (JP)

(72) Inventor: Takaaki TAKEDA, Tokyo (JP)

(73) Assignee: NEC Corporation, Tokyo (JP)

(21) Appl. No.: 18/539,574

(22) Filed: Dec. 14, 2023

(30) Foreign Application Priority Data
Dec. 20, 2022 (JP) 2022-202788

(51) Int. Cl. H04J 14/02

(52) U.S. Cl. CPC H04J 14/0227

(57) ABSTRACT

An optical transmission device is used in an optical transmission system in which a band of an optical fiber transmission path constituted of one optical fiber is shared by a plurality of users by using a wavelength multiplexed signal acquired by wavelength-multiplexing a plurality of optical signals, and includes: an optical monitor that outputs, for each wavelength associated with and allocated to each of the plurality of users, alarm information related to each of the plurality of optical signals; and a management device that transmits the alarm information of each wavelength being output from the optical monitor, to only a user with whom the wavelength is associated.

This application is based upon and claims the benefit of priority from Japanese Patent Application No. 2022-202788, filed on Dec. 20, 2022, the disclosure of which is incorporated here in its entirety by reference.

### TECHNICAL FIELD

The present disclosure relates to an optical transmission device and the like.

### BACKGROUND ART

An optical submarine cable system requires more cost and time for installing an optical cable than a land-based optical cable system. Therefore, a number of cases in which a plurality of business operators form a consortium and construct an optical submarine cable system is increasing. In such a case the plurality of business operators that construct the optical submarine cable system jointly own an optical fiber and a fiber pair. Further, a form is also known in which a plurality of cable owners (users) jointly own one fiber pair by logically partitioning an optical spectrum of an optical signal among a plurality of different business operators by using an optical spectrum sharing technique. Optical spectrum sharing is a technique in which a plurality of users use optical signals having different wavelengths from one another and thereby a band of an optical fiber is shared among the plurality of users by using wavelength division multiplexing (WDM).

FIG. 13 is a diagram illustrating a configuration example of a general optical transmission system 900. The optical transmission system 900 includes an optical transmission device 901, a monitoring network 902, an operation support system 903 (OSS-A), and an operation support system 904 (OSS-B). OSS is an abbreviation for “operation support system” and is a system that supports operation of an optical signal. The operation support systems 903 and 904 provide operational support for each own user. Specifically, the operation support system 903 is used by a user A for monitoring a status of an optical signal being transmitted through an optical fiber transmission path 950. Further, the operation support system 904 is used by a user B for monitoring a status of an optical signal being transmitted through the optical fiber transmission path 950.

The optical transmission device 901 includes wavelength multiplexing equipment (WME) 910 and an element management system (EMS) 920. The wavelength multiplexing equipment 910 includes a multiplexer 911 and an optical channel monitor (OCM) 912. The multiplexer 911 outputs, to the optical fiber transmission path 950, a wavelength division multiplexed signal (WDM signal) acquired by multiplexing n (n is an integer of two or more) optical signals that are transmitted from the user A and the user B. Wavelengths of each of the n optical signals from λ(1) to λ(n) are different from one another. The wavelengths from λ(1) to λ(n) are preliminarily allocated to each user. The optical channel monitor 912 sweeps a wavelength of the WDM signal being split by a coupler and the like and monitors power of each of the optical signals included in the WDM signal in real time. Further, the optical channel monitor 912 outputs information related to an alarm of each of the optical signals (alarm information) to the element management system 920. The element management system 920 notifies the operation support systems 903 and 904 of the alarm information notified by the optical channel monitor 912. Thereby, the operation support systems 903 and 904 can acquire the alarm information of the WDM signal.

In relation to the present disclosure, Patent Literature 1 (Japanese Unexamined Patent Application Publication No. 2009-88606) describes a configuration in which a submarine cable is connected to a plurality of base stations by using wavelength division multiplexing.

### SUMMARY

In optical spectrum sharing, a wavelength band of a WDM signal is shared by a plurality of business operators. Specifically, a capacity of an optical fiber transmission path is logically divided. Referring to FIG. 13, the general wavelength multiplexing equipment 910 being used in optical spectrum sharing is physically installed by one unit at each end of the optical fiber transmission path 950. Further, the wavelength multiplexing equipment 910 outputs, for each one physical optical fiber, only one notification (endpoint alarm) of WDM signal alarm information. Consequently, for example, even when the user A manages user A's own optical spectrum operation by using the operation support system 903, the user A is simultaneously notified of alarm information related to an optical signal of a wavelength being used by the user B. Consequently, the alarm information for user B, which is unnecessary for the user A, is mixed in alarm information to be notified to the user A. This causes a problem for the user A that it becomes complicated to manage the operation. Further in this case, against the user B's will, the alarm information related to the optical signal of the wavelength being used by the user B is notified to the user A sharing the same optical fiber with the user B. This causes a problem in terms of security of information related to a user B's own network. Further, a similar problem is also caused when the user B monitors an optical signal of a wavelength used by the user B, by using the operation support system 904.

An exemplary object of the disclosure is to provide a technique for enabling managing a notification destination of alarm information when one optical fiber is shared by a plurality of users through wavelength multiplexing.

An optical transmission device according to the present disclosure is an optical transmission device to be used in an optical transmission system in which a band of an optical fiber transmission path constituted of one optical fiber is shared by a plurality of users by using a wavelength multiplexed signal acquired by wavelength-multiplexing a plurality of optical signals, and includes: an optical monitor that outputs, for each wavelength associated with and allocated to each of the plurality of users, alarm information related to each of the plurality of optical signals; and a management means for transmitting the alarm information of each wavelength being output from the optical monitor, to only a user with whom the wavelength is associated.

An optical transmission method according to the present disclosure is an optical transmission method to be used in an optical transmission system in which a band of an optical fiber transmission path constituted of one optical fiber is shared by a plurality of users by using a wavelength multiplexed signal acquired by wavelength-multiplexing a plurality of optical signals, and includes: a procedure of outputting, for each wavelength associated with and allocated to each of the plurality of users, alarm information related to each of the plurality of optical signals; and a procedure of transmitting the alarm information of each wavelength to only a user with whom the wavelength is associated.

The present disclosure enables managing a notification destination of alarm information when one optical fiber is shared by a plurality of users through wavelength multiplexing.

### BRIEF DESCRIPTION OF THE DRAWINGS

Exemplary features and advantages of the present disclosure will become apparent from the following detailed description when taken with the accompanying drawings in which:

FIG. 1 is a diagram illustrating a configuration example of an optical transmission system;

FIG. 2 is a diagram illustrating an example of wavelength information;

FIG. 3 is a diagram illustrating an example of address information;

FIG. 4 is a diagram illustrating a configuration example of the optical transmission system;

FIG. 5 is a diagram illustrating an example of the wavelength information;

FIG. 6 is a diagram illustrating an example of the address information;

FIG. 7 is a diagram illustrating an example of user information;

FIG. 8 is a diagram illustrating a configuration example of an optical transmission system;

FIG. 9 is a diagram illustrating a configuration example of an optical transmission system;

FIG. 10 is a diagram illustrating an example of wavelength information;

FIG. 11 is a diagram illustrating an example of wavelength information;

FIG. 12 is a diagram illustrating an example of address information; and

FIG. 13 is a diagram illustrating a configuration example of a general optical transmission system.

### EXAMPLE EMBODIMENT

In the following, example embodiments of the present disclosure is described with reference to the drawings. While an arrow illustrated in the drawings exemplifies a direction of a signal and the like, the disclosure is not limited to the direction of the signal and the like. In each embodiment and drawing, the same reference sign is given to an element that has already been described, and overlapping description may be omitted.

### First Example Embodiment

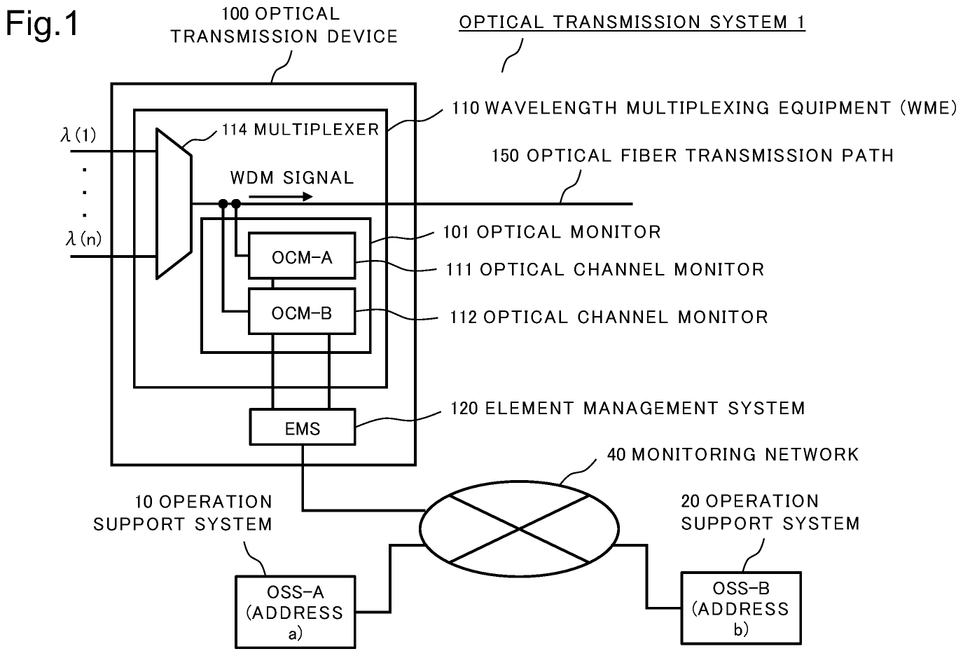

FIG. 1 is a diagram illustrating a configuration example of an optical transmission system 1 according to a first example embodiment of the present disclosure. The optical transmission system 1 includes an optical transmission device 100, an operation support system A (OSS-A) 10, an operation support system B (OSS-B) 20, and a monitoring network 40.

The optical transmission device 100 includes a wavelength multiplexing equipment (WME) 110 and an element management system (EMS) 120. The wavelength multiplexing equipment 110 includes an optical monitor 101 and multiplexer 114. The multiplexer 114 is optically connected to a user line that receives n (n is an integer of two or more) optical signals from a plurality of users to an optical fiber transmission path 150, and to optical channel monitors 111 and 112 of the optical monitor 101. The multiplexer 114 outputs a wavelength division multiplexed signal (WDM signal) acquired by multiplexing the n optical signals to the optical fiber transmission path 150. The optical fiber transmission path 150 is an optical fiber transmission path constituted of one optical fiber and outputs the WDM signal to an outside of the optical transmission device 100. Wavelengths from λ(1) to λ(n) of each of the n optical signals are different from each other. The wavelengths from λ(1) to λ(n) are arranged, for example, in order of increasing wavelength. Further, the wavelength from λ(1) to λ(n) are preliminarily allocated to a user A and a user B. A single wavelength is never allocated to both the user A and the user B. In this way, in the optical transmission system 1, a band of the one optical fiber is shared by the plurality of users by using the plurality of wavelength-multiplexed optical signals. The optical transmission device 100 is one form of an optical transmitter.

The optical monitor 101 includes the optical channel monitor 111 (OCM-A) and the optical channel monitor 112 (OCM-B). The WDM signal output from the multiplexer 114 is distributed to the optical channel monitors 111 and 112 by a coupler and the like. The distributed WDM signal is input to the optical channel monitors 111 and 112. The optical channel monitors 111 and 112 sweep a wavelength of the input WDM signal and thereby acquires power of each of the optical signals included in the WDM signal.

The optical channel monitor 111 is optically connected to the multiplexer 114 and the element management system 120. The optical channel monitor 112 is optically connected to the multiplexer 114 and the element management system 120. The optical channel monitor 111 according to the present example embodiment further outputs, based on the acquired power, alarm information related to an optical signal of which wavelength is allocated to the user A to the element management system 120. Likewise, the optical channel monitor 112 further outputs, based on a monitoring result, alarm information related to an optical signal of which wavelength is allocated to the user B to the element management system 120. The alarm information is information indicating, for each of the optical signals included in the WDM signal, whether an anomaly is present. For example, when power of an optical signal having a specific wavelength falls below a prescribed value, an alarm related to the optical signal having the wavelength is included in the alarm information. Specifically, the optical monitor 101 outputs alarm information related to each of the plurality of optical signals, for each of the wavelengths allocated to each of the plurality of users.

The element management system 120 is optically connected to the optical channel monitors 111 and 112 and the monitoring network 40. The element management system 120 transmits the alarm information input from the optical channel monitors 111 and 112 to the operation support system 10 or 20, via the monitoring network 40. Herein, the element management system 120 notifies alarm information related to each of the optical signals having wavelengths from λ(1) to λ(n) to only a user to whom the wavelength is allocated. The monitoring network 40 is a network connecting the element management system 120 and an operation support system of each user. The operation support systems 10 and 20 are operation support systems for the user A and user B, respectively. In the present example embodiment, the operation support system 10 is used by the user A to monitor a status of an optical signal having a wavelength allocated to the user A. Further, the operation support system 20 is used by the user B to monitor a status of an optical signal having a wavelength allocated to the user B. Specifically, the operation support system 10 exclusively performs operation management of an optical signal having a wavelength that the user A uses. Further, the operation support system 20 exclusively performs operation management of an optical signal having a wavelength that the user B uses.

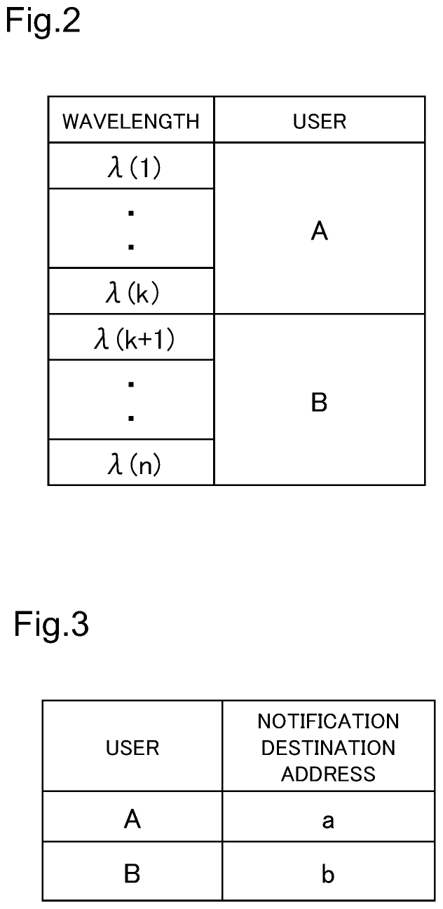

FIG. 2 is a diagram illustrating an example of wavelength information referred to by the optical channel monitors 111 and 112. The wavelength information is data that the optical channel monitors 111 and 112 can refer to and indicates allocation of the wavelengths of the optical signals included in the WDM signal for the users. The wavelength information may be stored in a storage device such as a semiconductor memory included in the optical transmission device 100.

The wavelength information in FIG. 2 indicates that optical signals having wavelengths from λ(1) to λ(k) are allocated to the user A and optical signals having wavelengths from λ(k+1) to λ(n) are allocated to the user B. k and n are positive integers that satisfies 1≤ k<n. A and B are identifiers for identifying the plurality of users and a username is used as the identifier in the present example embodiment. Specifically, the wavelength information indicates correspondence between the wavelengths from λ(1) to λ(n) of the plurality of optical signals and the identifiers that identifies the plurality of users.

The optical channel monitor 111 refers to the wavelength information, selects alarm information related to optical signals having the wavelengths from λ(1) to λ(k) allocated to the user A, and output the selected alarm information. Likewise, the optical channel monitor 112 refers to the wavelength information, selects alarm information related to optical signals having the wavelengths from λ(k+1) to λ(n) allocated to the user B, and outputs the selected alarm information. Further, the optical channel monitors 111 and 112 output alarm information related to each of the optical signals, in association with the user for each of the optical signals. In the optical transmission system 1, when the wavelength allocated to the user A and the user B is changed, data of the wavelength information is also updated.

Note that, when the allocation of wavelength for each user is fixed, the wavelength information may be fixedly incorporated into hardware of the optical channel monitors 111 and 112 through a method such as fixing transmission wavelengths of optical filters of the optical channel monitors 111 and 112, and the like. In this case, the optical transmission device 100 does not need to store the wavelength information as data.

FIG. 3 is a diagram illustrating an example of address information referred to by the element management system 120. The address information indicates, for each of the users, an address of a notification destination of alarm information. The address information is data that the element management system 120 can refer to, and may be stored in the storage device such as a semiconductor memory included in the optical transmission device 100. The address information in FIG. 3 indicates that a notification destination address of the user A is a, and that a notification destination address of the user B is b. The notification destination address is an address of the operation support system of each of the users. The notification destination addresses a and b are addresses in a format in which the monitoring network 40 can route the alarm information and are, for example, Internet protocol (IP) addresses. However, the format of the notification destination addresses is not limited to the above-described format. In the optical transmission system 1, when any of the notification destination address of the operation support systems 10 and 20 is changed, data in the address information is also updated. Thus, the address information indicates correspondence between an identifier and a transmission destination of alarm information for each identifier.

The element management system 120 refers to a user and address information that are associated with the alarm information received from the optical monitor 101. Further, the element management system 120 transmits the alarm information related to the optical signal for the user A, to only the operation support system 10 (notification destination address a) of the user A. Further, the element management system 120 transmits the alarm information related to the optical signal for the user B to only the operation support system 20 (notification destination address b) of the user B. Specifically, the element management system 120 notifies alarm information input from the optical channel monitors 111 and 112 to only a user who uses an allocated wavelength and does not notify the alarm information to a user who does not use the allocated wavelength. In this way, the element management system 120 transmits the alarm information for each of the wavelengths input from the optical monitor 101 to only the user who uses the wavelength.

In this way, the optical transmission device 100 enables managing a notification destination of alarm information when a plurality of users share one optical fiber through optical spectrum sharing. Specifically, according to the optical transmission device 100, a notification destination of alarm information can be managed when one optical fiber is shared by a plurality of users through wavelength multiplexing. Consequently, for example, the user A can receive the alarm information related to the optical signal having the wavelength allocated to the user A, but cannot receive the alarm information related to the optical signal having the wavelength allocated to the user B. Further, the user B can receive the alarm information related to the optical signal having the wavelength allocated to the user B, but cannot receive the alarm information related to the optical signal having the wavelength allocated to the user A. Further, by being able to manage the notification destination of alarm information, the user A and the user B can each prevent that management of the alarm information becomes complicated and can ensure security of information related to their own networks.

The wavelength information and the address information may be collectively referred to as “user information”. The user information is information indicating correspondence between the wavelengths of the plurality of optical signals and the information on the plurality of users. The optical transmission device 100 notifies the alarm information to only the user who uses the allocated wavelength, based on the user information.

Note that, the wavelength information illustrated in FIG. 2 is an example, and the wavelengths from λ(1) to λ(n) of the optical signals included in the WDM signal may be allocated to the user A and the user B without overlap. For example, the odd-numbered wavelengths wavelength (λ(1), λ(3), . . . ) may be allocated to the user A and the even-numbered wavelengths (λ(2), λ(4), . . . ) may be allocated to the user B. Further, there may also be a wavelength that is not allocated to any user.

### Minimum Configuration of First Example Embodiment

The advantageous effect of the optical transmission device 100 illustrated in FIG. 1 may also achieved by an optical transmission device with a configuration described in the following. A component corresponding that in FIG. 1 is described with parentheses.

An optical transmission device (100) is used in an optical transmission system in which a band of an optical fiber transmission path (150) constituted of one optical fiber is shared by a plurality of users by using a wavelength multiplexed signal acquired by multiplexing a plurality of optical signals. The optical transmission device (100) includes an optical monitor (101) and a management circuit (120). The optical monitor (101) outputs for each wavelength associated with and allocated to each of a plurality of users, alarm information related to each of the plurality of optical signals. The management circuit (120) transmits the alarm information for each wavelength output from the optical monitor (101) to only a user with whom the wavelength is associated. The element management system 120 in FIG. 1 is one form of the management circuit (120).

The optical transmission device (100) with a minimum configuration enables managing a notification destination of alarm information when a plurality of users share one optical fiber through optical spectrum sharing. A reason for this is that the optical transmission device (100) is configured in such a way as to transmit the alarm information for each wavelength of optical signals included in a WDM signal to only a user who uses the wavelength.

### First Modification Example of First Example Embodiment

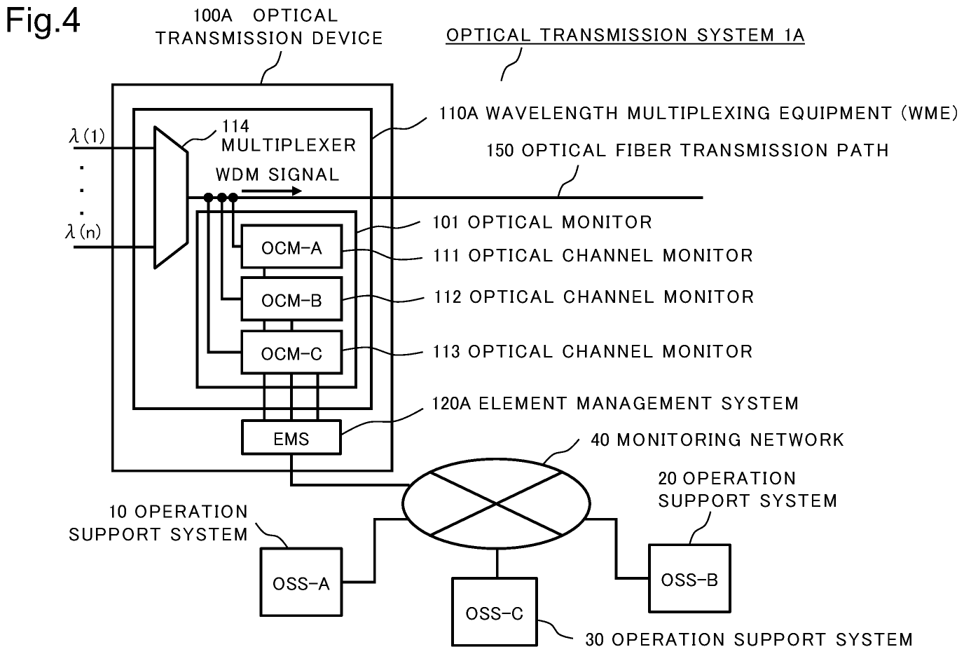

FIG. 4 is a diagram illustrating a configuration example of an optical transmission system 1A which is a modification example of the first example embodiment of the present disclosure. In the optical transmission system 1A, a user A, a user B, and a user C transmits an optical signal while sharing one optical fiber through optical spectrum sharing. The optical transmission system 1A includes an optical transmission device 100A, a monitoring network 40, an operation support system A (OSS-A) 10, an operation support system B (OSS-B) 20, and an operation support system C (OSS-C) 30. The OSS-C is a system that exclusively performs operation management for the user C.

The optical transmission device 100A includes a wavelength multiplexing equipment (WME) 110A and an element management system (EMS) 120A. The wavelength multiplexing equipment 110A includes optical channel monitors 111, 112, 113, and a multiplexer 114. The multiplexer 114 outputs a WDM signal acquired by multiplexing n optical signals transmitted from each of the user A, B, and C to the optical fiber transmission path 150. Wavelengths from λ(1) to λ(n) of each of the n optical signals are different from each other. Further, the wavelengths from λ(1) to λ(n) are preliminarily allocated to the users A, B, and C. However, a single wavelength is never allocated to two or more of the user A, the user B, and the user C.

The optical channel monitors 111 to 113 sweeps a wavelength of the WDM signal distributed from the optical fiber transmission path 150 by a coupler and the like and acquires power of each of the optical signals included in the WDM signal. Then, the optical channel monitor 111 outputs alarm information related to an optical signal having the wavelength allocated to the user A to the element management system 120A. The optical channel monitor 112 outputs alarm information related to an optical signal having the wavelength allocated to the user B to the element management system 120A. The optical channel monitor 113 outputs alarm information related to an optical signal having the wavelength allocated to the user C to the element management system 120 A.

The element management system 120A transmits the alarm information input from the optical channel monitors 111 to 113 to the operation support system 10, 20, or 30, via the monitoring network 40. Herein, element management system 120A notifies the alarm information related to the optical signals having the wavelengths from λ(1) to λ(n) to only the operation support system of the user who uses the wavelength. The monitoring network 40 connects the element management system 120A to the operation support systems 10, 20 and 30 of each user. Each of the operation support systems 10, 20 and 30 is an operation support system that each of the users A, B and C installs for itself. The operation support system 30 added in the present example embodiment is used by the user C for monitoring a status of an optical signal having the wavelength occupied by the user C. The element management system 120 A notifies the alarm information related to the optical signals having the wavelengths from λ(1) to λ(n) input from the optical channel monitors 111 to 113 to only the operation support system of the user who uses the wavelength.

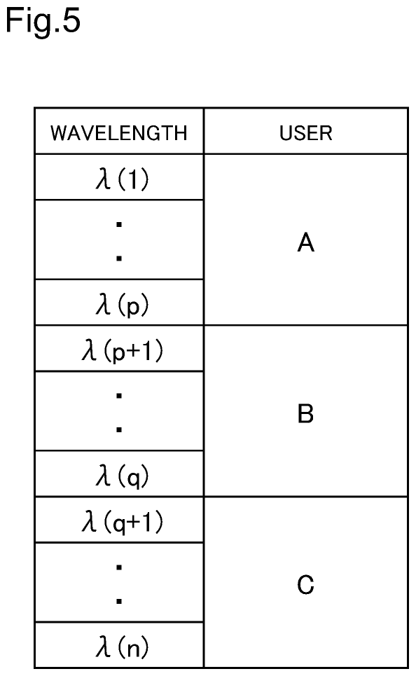

FIG. 5 is a diagram illustrating an example of wavelength information referred to by the optical channel monitor 111 to 113 on the present example embodiment. The wavelength information in FIG. 5 indicates that the optical signals having the wavelengths from λ(1) to λ(p) are allocated to the user A, the optical signals having the wavelengths from λ(p+1) to λ(q) are allocated to the user B, and the optical signals having the wavelengths from λ(q+1) to λ(n) are allocated to the user C. p and q are positive integers that satisfy 1≤ p<q<n. The optical channel monitor 111 refers to the wavelength information and outputs alarm information related to the wavelength allocated to the user A to the element management system 120A, in association with the user. The optical channel monitor 112 refers to the wavelength information and output alarm information related to the wavelength allocated to the user B to the element management system 120A in association with user. The optical channel monitor 113 refers to the wavelength information and outputs alarm information related to the wavelength allocated to the user C to the element management system 120A in association with the user.

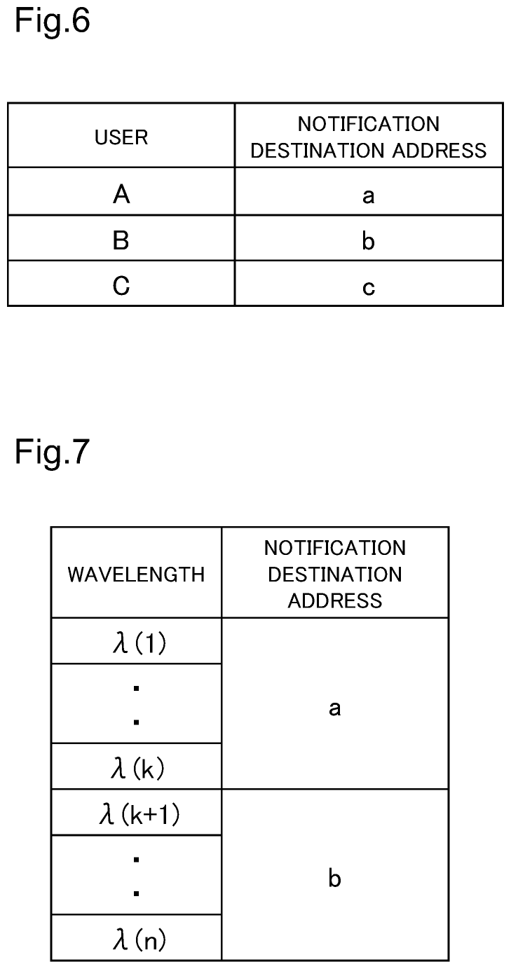

FIG. 6 is a diagram illustrating an example of address information referred to by the element management system 120A. The address information in FIG. 6 indicates that notification destination addresses of the user A, the user B, and the user C are a, b, and c, respectively. The notification destination addresses a, b, and c are addresses to which the monitoring network 40 can route the alarm information and are, for example, IP addresses.

The element management system 120A refers to the address information and the alarm information and transmits the alarm information related to an optical signal of the user A received from the optical channel monitor 111 to only the operation support system 10 of user A. Further, the element management system 120A transmits the alarm information related to an optical signal of the user B received from the optical channel monitor 112 to only the operation support system 20 of the user B. Further, the element management system 120 A refers to the address information and transmits the alarm information related to an optical signal of the user C received from the optical channel monitor 113 to only the operation support system 30 (notification destination address c) of the user C. Specifically, the element management system 120A notifies alarm information for each of the wavelengths input from the optical channel monitors 111 to 113 to only a user who uses an allocated wavelength and does not notify the alarm information to a user who does not use the allocated wavelength.

In this way, similar to the optical transmission device 100, the optical transmission device 100A enables managing a notification destination of alarm information when a plurality of users share one optical fiber through optical spectrum sharing. Consequently, for example, the user A can receive only alarm information related to an optical signal having the wavelength allocated to the user A, but cannot receive alarm information related to an optical signal having the wavelengths allocated to the user B and the user C. The same applies to the user B and the user C. Thereby, the user A, the user B, and the user C can prevent that management of the alarm information becomes complicated in their own operation support systems and can ensure security of information related to their own networks.

### Second Modification Example of First Example Embodiment

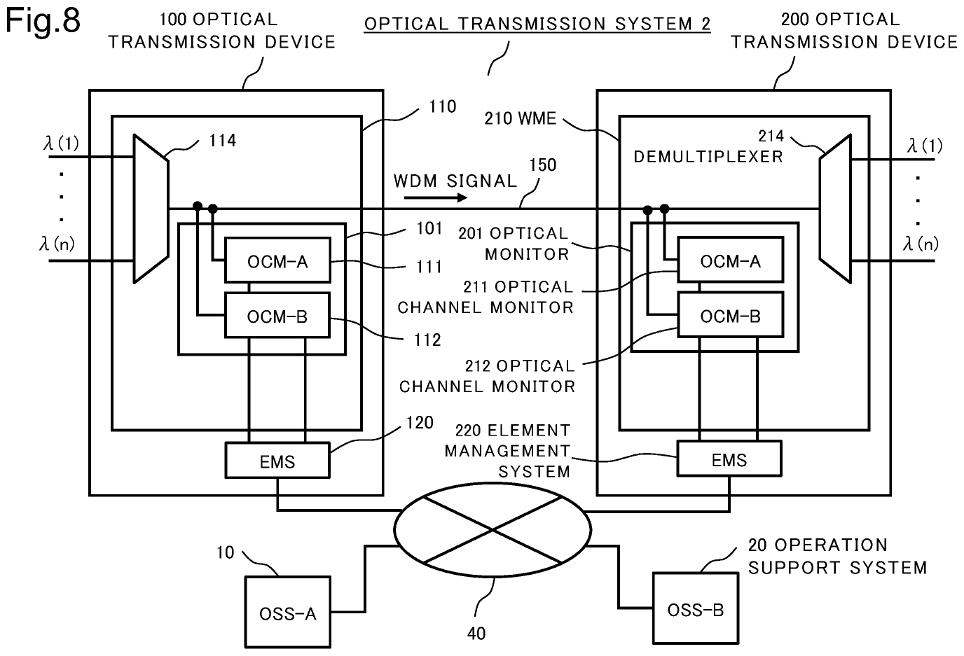

FIG. 7 is a diagram illustrating an example of user information according to a second modification example of the first example embodiment. The user information in FIG. 7 indicates correspondence between a wavelength of an optical signal and a notification destination address of alarm information for the wavelength. The optical transmission device 100 illustrated in FIG. 1 may transmit the alarm information to only the user who uses the wavelength, by referring to the user information in FIG. 7 by either one of the optical monitor 101 and the element management system 120.

For example, any one of the optical channel monitors 111 and 112 included in the optical monitor 101 refers to the user information in FIG. 7 and outputs alarm information related to an optical signal having each wavelength included in a WDM signal to the element management system 120, in association with each notification destination address. In this case, the element management system 120 can transmit the alarm information input from the optical channel monitor 111 or 112 to the associated notification destination address without using the address information.

Alternatively, the optical channel monitor 111 or 112 may output the alarm information of all the optical signals included in the WDM signal to the element management system 120, in association with wavelengths without using the wavelength information. The element management system 120 refers to the user information in FIG. 7 and acquires, a notification destination address of alarm information for each wavelength. Then, the element management system 120 transmits the alarm information input by the optical channel monitors 111 or 112 to each notification destination address of the alarm information.

In this way, the optical transmission device 100 according to the present modification example uses the user information indicating correspondence between the wavelengths of the plurality of optical signals and information of the plurality of users. In this configuration, only one type of user information is required and only alarm information related to an optical signal having a wavelength used by a user being a notification destination can be notified to the user by referring to user information by either one of the optical monitor 101 and the element management system 120.

### Second Example Embodiment

FIG. 8 is a diagram illustrating a configuration example of an optical transmission system 2 according to a second example embodiment of the present disclosure. The optical transmission system 2 differs in that the optical transmission system 2 includes the optical transmission device 100 described in the first example embodiment and an optical transmission device 200 that receives a WDM signal transmitted by the optical transmission device 100. The optical transmission device 200 includes a wavelength multiplexing equipment (WME) 210 and an element management system (EMS) 220. The wavelength multiplexing equipment 210 includes an optical monitor 201 and a demultiplexer 214. The optical monitor 201 includes optical channel monitors 211 and 212. The demultiplexer 214 demultiplexes (wavelength-demultiplexes) a received WDM signal by wavelength and outputs the demultiplexed WDM signal as n optical signals having wavelengths from λ(1) to λ(n). Each of the optical signals is transmitted to each user by an unillustrated transmission device connected to a subsequent stage of the optical transmission device 200. The optical transmission device 200 is one form of an optical receiver.

The optical transmission device 100 outputs a WDM signal to an optical fiber transmission path 150. The optical transmission device 200 receives the WDM signal that has propagated through the optical fiber transmission path 150. The received WDM signal is distributed to the optical channel monitors 211 and 212 by a coupler and the like. The optical channel monitors 211 and 212 sweeps a wavelength of the WDM signal and acquires power of each optical signal included in the WDM signal. Then, the optical channel monitor 211 outputs, based on the acquired power, alarm information related to an optical signal having a wavelength allocated to the user A to the element management system 220. Likewise, the optical channel monitor 212 outputs, based on a monitoring result, alarm information related to an optical signal having a wavelength allocated to the user B to the element management system 220.

The element management system 220 transmits the alarm information notified by the optical channel monitors 211 and 212 to an operation support system 10 or 20 via the monitoring network 40. By using a similar procedure as in the first example embodiment, the element management system 220 notifies the alarm information input from the optical channel monitors 211 and 212 to only a user who uses the wavelength.

For example, the optical channel monitors 211 and 212 refers to the wavelength information illustrated in FIG. 2 in order to output, to each of the users, the alarm information of the WDM signal received by the optical transmission device 200. The wavelength information is stored also in a storage device such as a semiconductor memory included in the optical transmission device 200. The optical channel monitor 211 refers to the wavelength information and outputs only alarm information related to the wavelength allocated to the user A to the element management system 220. Further, the optical channel monitor 212 refers to the wavelength information and outputs only alarm information related to wavelength allocated to the user B to the element management system 220.

The element management system 220 may refer to the address information illustrated in FIG. 3 and transmit the alarm information for each user to the operation support systems 10 and 20. The address information is data that the element management system 220 can refer to and may be stored in the storage device such as a semiconductor memory included in the optical transmission device 200.

Specifically, the element management system 220 refers to the address information and transmits alarm information related to optical signal of the user A received from the optical channel monitor 211 to only the operation support system 10 (notification destination address a) of the user A. Further, the element management system 220 transmits alarm information related to an optical signal of the user B received from the optical channel monitor 212 to only the operation support system 20 (notification destination address b) of the user B. Specifically, the element management system 220 notifies alarm information for each wavelength input by the optical channel monitors 211 and 212 to only a user who uses an allocated wavelength and does not notify the alarm information to a user who does not use the allocated wavelength.

In this way, the optical transmission devices 100 and 200 and the optical transmission system 2 including them enable managing a notification destination of alarm information of a received WDM signal when a plurality of users share one optical fiber through optical spectrum sharing. Consequently, for example, the user A can receive only alarm information when an optical signal having the wavelength allocated to the user A is received but cannot receive alarm information when an optical signal having the wavelength allocated to the user B is received. The same applies to the user B.

Specifically, each of the user A and the user B can prevent that management of alarm information becomes complicated, not only when transmitting a WDM signal but also receiving a WDM signal and can ensure security of information related to their own networks.

### Third Example Embodiment

A technique of logically partitioning, among a plurality of business operators, an optical spectrum of a WDM signal that propagates through one fiber pair (FP) included in an optical submarine cable is also known. By using this technique, a plurality of cable owners jointly own one fiber pair.

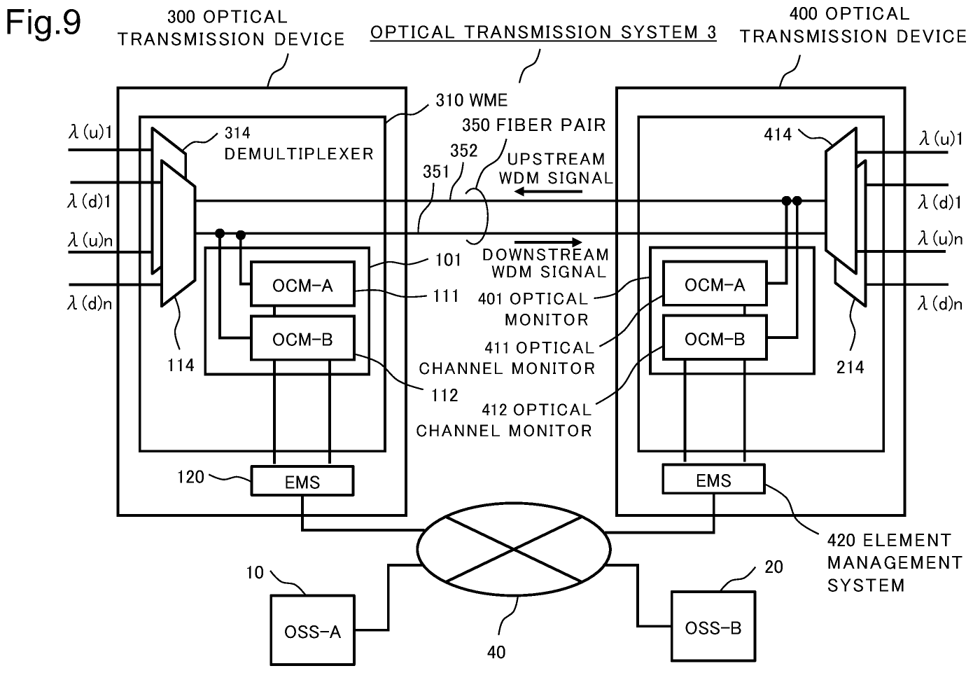

FIG. 9 is a diagram illustrating a configuration example of an optical transmission system 3 according to a third example embodiment of the present disclosure. In the optical transmission system 3, an optical transmission device 300 and an opposing optical transmission device 400 are connected to each other by a fiber pair 350. The fiber pair includes two independent optical fibers, fibers 351 and 352.

The optical transmission system 3 is configured in such a way that the optical transmission device 300 and the optical transmission device 400 are opposite to each other and bidirectional transmission using the fiber pair 350 is possible. The optical transmission devices 300 and 400 includes the components of the optical transmission device 100 described in the first example embodiment. In the present example embodiment, a direction from the optical transmission device 300 to the optical transmission device 400 is referred to as “downstream” and a direction from the optical transmission device 400 to the optical transmission device 300 is referred to as “upstream”.

The optical transmission device 300 includes a wavelength multiplexing equipment (WME) 310 and an element management system 120. The wavelength multiplexing equipment 310 includes a demultiplexer 314 in addition to an optical monitor 101 and a multiplexer 114. The optical transmission device 300 transmits a downstream WDM signal to the fiber 351 by the same operation as the optical transmission device 100. Specifically, the multiplexer 114 outputs, to the fiber 351, a downstream WDM signal acquired by multiplexing n downstream optical signals input by a user A and a user B. An optical channel monitor 111 outputs, alarm information related to an optical signal included in a downstream WDM signal of the user A, in association with the user for each wavelength. An optical channel monitor 112 outputs, alarm information related to an optical signal included in a downstream WDM signal of the user B, in association with the user for each wavelength.

The element management system 120 transmits the alarm information related to the downstream optical signal notified by the optical channel monitors 111 and 112 to an operation support system 10 or via a monitoring network 40. An element management system 320 notifies the alarm information related to the downstream optical signal to only a user who uses the wavelength.

The optical transmission device 300 includes the demultiplexer 314 in order to receive an upstream WDM signal received from the fiber 352. The demultiplexer 314 demultiplexes optical signals included in the upstream WDM signal received from the fiber 352 by wavelength and outputs the demultiplexed signals as optical signals having wavelengths from λu(1) to λu(n). Each of the optical signals is transmitted to each of the users according to wavelength information.

A configuration and operation of the optical transmission device 400 are different from the configuration of the optical transmission device 300 only in a direction of optical signal and WDM signal, and therefore a detailed description thereof is omitted. Specifically, the optical transmission device 400 receives the downstream WDM signal transmitted by the optical transmission device 300 from the fiver 351. The demultiplexer 214 demultiplexes the downstream WDM signal and outputs the demultiplexed downstream WDM signal as downstream optical signals having wavelengths from λd(1) to λd(n). Further, the optical transmission device 400 receives the upstream optical signals having the wavelengths from λu(1) to λu(n) from each of the users. The multiplexer 414 multiplexes the upstream optical signals and outputs the multiplexed upstream optical signals as an upstream WDM signal to the fiber 352. An optical monitor 401 includes optical channel monitors 411 and 412. The optical channel monitor 411 outputs alarm information of an upstream WDM signal of the user A, in association with a wavelength. The optical channel monitor 412 outputs alarm information of an upstream WDM signal of the user B, in association with a wavelength.

An element management system 420 transmits the alarm information related to the upstream optical signals input from the optical channel monitors 411 and 412 to the operation support system 10 or 20 via the monitoring network 40. The element management system 420 notifies alarm information related to the upstream optical signal to only a user who uses the wavelength.

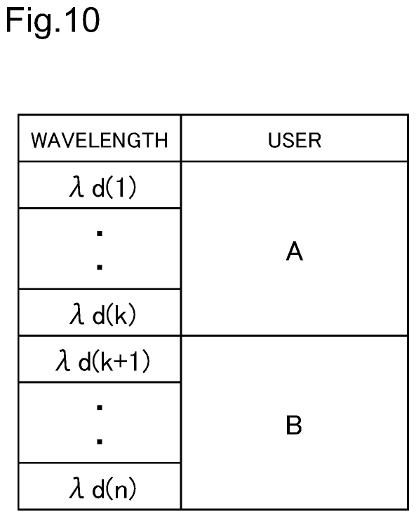

FIG. 10 is a diagram illustrating an example of wavelength information referred to by the optical channel monitors 111 and 112. The wavelength information in FIG. 10 indicates that downstream optical signals having wavelengths from λd(1) to λd(k) are allocated to the user A and downstream optical signals having wavelengths from λd(k+1) to λd(n) are allocated to the user B. The optical channel monitor 111 refers to the wavelength information and outputs only alarm information related to a downstream optical signal having the wavelength allocated to the user A to the element management system 320. Further, the optical channel monitor 112 outputs only alarm information related to a downstream optical signal having the wavelength allocated to the user B to the element management system 320.

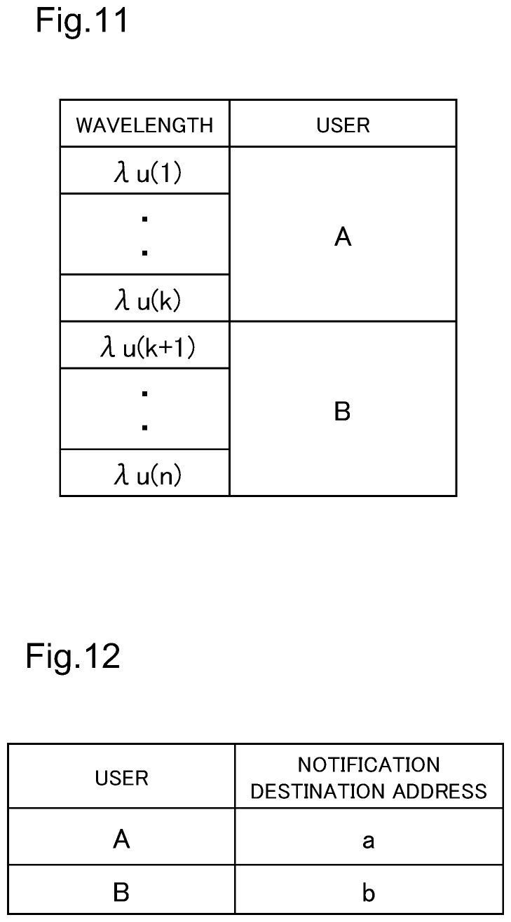

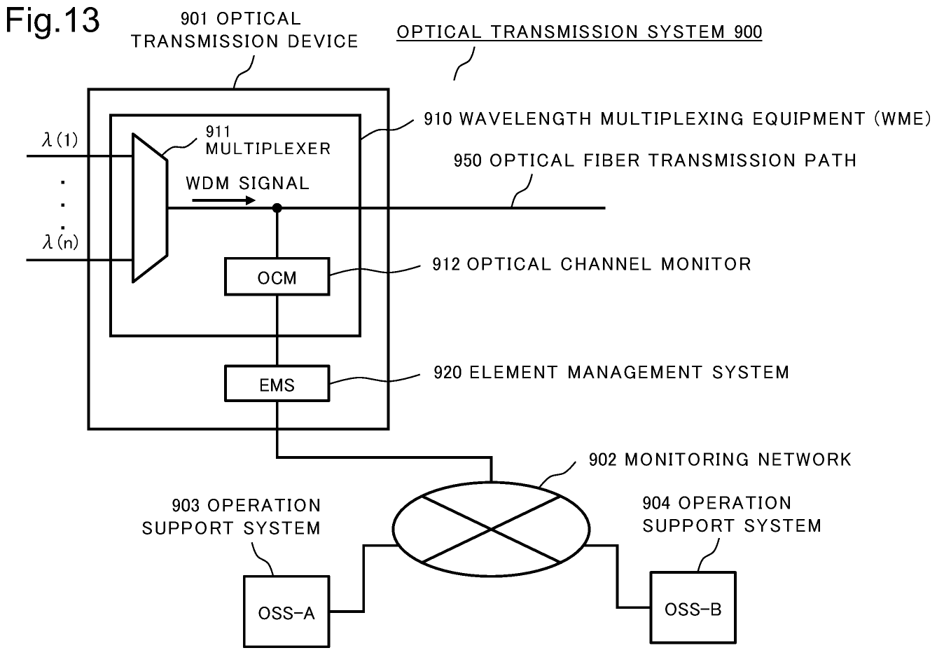

FIG. 11 is a diagram illustrating an example of wavelength information referred to by the optical channel monitors 411 and 412. The wavelength information in FIG. 10 indicates that upstream optical signals having wavelengths from λu(1) to λu(k) are allocated to the user A and upstream optical signals having wavelengths from λu(k+1) to λu(n) are allocated to the user B.

The optical channel monitors 411 and 412 execute processing similar to the processing executed by the optical channel monitors 111 and 112, for the upstream optical signals. Specifically, the optical channel monitor 411 outputs only alarm information related to an upstream optical signal having the wavelength allocated to the user A to the element management system 420. Further, the optical channel monitor 412 outputs only alarm information related to an upstream optical signal having the wavelength allocated to the user B to the element management system 420.

FIG. 12 is a diagram illustrating an example of address information referred to by the element management systems 120 and 420. The address information is data that the element management systems 120 and 420 can refer to. The address information may be stored in a storage device such as a semiconductor memory included in each of the optical transmission devices 300 and 400. Alternatively, the address information may be stored in a storage device accessible by both of the optical transmission devices 300 and 400. Similar to the address information in FIG. 3, the address information in FIG. 12 indicates that a notification destination address of the user A is a and a notification destination address of the user B is b. The notification destination address is an address of the operation support system of each of the users. The notification destination addresses a and b are addresses to which the monitoring network 40 can route the alarm information and are, for example, IP addresses.

In this way, the optical transmission devices 300, 400 and the optical transmission system 3 enable managing a notification destination of alarm information of a transmitted WDM signal when a plurality of users share one fiber pair through optical spectrum sharing. Consequently, for example, the user A can receive alarm information when an optical signal having the wavelength allocated to the user A is received but cannot receive alarm information when an optical signal having the wavelength allocated to the user B is received. Further, the user B can receive alarm information when an optical signal having the wavelength allocated to the user B is received but cannot receive alarm information when an optical signal having the wavelength allocated to the user A is received.

Thereby, the user A and the user B can prevent that management of alarm information related to optical signals they use becomes complicated and can ensure security of information related to their own networks, even when performing bidirectional transmission using a fiber pair.

In each of the example embodiments, a procedure executed in the optical channel monitor and the element management system may be achieved by a central processing unit (CPU) included in the optical transmission device including each of the optical channel monitor and the element management system executing a control program. The control program is stored in a fixed non-transitory recording medium. The recording medium is, for example, a semiconductor memory or a fixed magnetic disk device, but is not limited thereto. The CPU is, for example, a computer included in the optical transmission device.

Note that, the example embodiments of the present disclosure may be described as the following supplementary notes but are not limited thereto.

### (Supplementary Note 1)

An optical transmission device used in an optical transmission system in which a band of an optical fiber transmission path constituted of one optical fiber is shared by a plurality of users by using a wavelength multiplexed signal acquired by wavelength-multiplexing a plurality of optical signals, the optical transmission device including:
an optical monitor that outputs, for each wavelength associated with and allocated to each of the plurality of users, alarm information related to each of the plurality of optical signals;
a management means for transmitting the alarm information for each wavelength being output from the optical monitor, to only a user with whom the wavelength is associated.

### (Supplementary Note 2)

The optical transmission device according to supplementary note 1, wherein the alarm information is notified, based on user information indicating correspondence between wavelengths of the plurality of optical signals and information of the plurality of users, to only a user who uses the wavelength.

### (Supplementary Note 3)

The optical transmission device according to supplementary note 2, wherein
the user information includes:
wavelength information indicating correspondence between wavelengths of the plurality of optical signals and identifiers for identifying the plurality of users; and
address information indicating correspondence between the identifier and a transmission destination of the alarm information for each of the identifiers.

### (Supplementary Note 4)

The optical transmission device according to supplementary note 3, wherein
the optical monitor outputs the alarm information to the management means, based on the wavelength information, and
the management means notifies, based on the address information, the alarm information to only a user who uses the wavelength among the plurality of users.

### (Supplementary Note 5)

The optical transmission device according to supplementary note 4, wherein
the optical monitor includes a plurality of optical channel monitors each of which is associated with the plurality of users on a one-to-one basis, and
the plurality of optical channel monitors output the alarm information of the optical signal having a wavelength allocated to the associated user.

### (Supplementary Note 6)

The optical transmission device according to supplementary note 2, wherein the management means notifies, based on the user information, the alarm information to only a user who uses the wavelength.

### (Supplementary Note 7)

The optical transmission device according to any one of supplementary notes 1 to 6, further including a multiplexer that wavelength-multiplexes the plurality of optical signals and outputs the wavelength-multiplexed optical signals to the optical fiber transmission path, wherein
the optical monitor outputs the alarm information of the plurality of optical signals being output from the multiplexer.

### (Supplementary Note 8)

The optical transmission device according to any one of supplementary notes 1 to 6, further including a demultiplexer that outputs the plurality of optical signals acquired by wavelength-demultiplexing the plurality of optical signals received from the optical fiber transmission path, wherein
the optical monitor outputs the alarm information of the plurality of optical signals being input to the demultiplexer.

### (Supplementary Note 9)

An optical transmission system including:
the optical transmission device according to supplementary note 7 that outputs the plurality of wavelength-multiplexed optical signals to the optical fiber transmission path;
the optical fiber transmission path; and
an optical receiver that receives the plurality of optical signals received from the optical fiber transmission path.

### (Supplementary Note 10)

The optical transmission system according to supplementary note 9, further including an operation support system that is installed for each of the plurality of users and receives the alarm information being output by the management means.

### (Supplementary Note 11)

The optical transmission system according to supplementary note 9 or 10, wherein the optical fiber transmission path is any of optical fibers included in one fiber pair.

### (Supplementary Note 12)

The optical transmission system according to any one of supplementary notes 9 to 11, wherein the optical receiver is the optical transmission device according to supplementary note 8.

### (Supplementary Note 13)

An optical transmission method to be used in an optical transmission system in which a band of an optical fiber transmission path constituted of one optical fiber is shared by a plurality of users by using a wavelength multiplexed signal acquired by wavelength-multiplexing a plurality of optical signals, the method including:
outputting, for each wavelength associated with and allocated to each of the plurality of users, alarm information related to each of the plurality of optical signals; and
transmitting the alarm information for each wavelength to only a user with whom the wavelength is associated.

### (Supplementary Note 14)

The optical transmission method according to supplementary note 13, further including notifying, based on user information indicating correspondence between wavelengths of the plurality of optical signals and information of the plurality of users, the alarm information to only a user who uses the wavelength.

While the disclosure has been particularly shown and described with reference to exemplary embodiments thereof, the disclosure is not limited to these embodiments. It will be understood by those of ordinary skill in the art that various changes in form and details may be made therein without departing from the spirit and scope of the present disclosure as defined by the claims. For example, the optical transmission device described in the example embodiment also discloses an example embodiment of the optical transmission system including the optical transmission device and of a procedure of the optical transmission method executed by the optical transmission device.

The configurations described in the example embodiments are not necessarily exclusive of each another. Action and the advantageous effect of the present disclosure may be achieved by a configuration combining all or some of the above-described example embodiments. For example, the configuration described with reference to FIGS. 4 to 6, where the number of users is three, may be applied to other example embodiments. Further, it is clear that the configuration and operation of each of the example embodiments may be applied when the number of users is equal to or more than four.

### REFERENCE SIGNS LIST

Optical transmission system
1, 1A, 2, 3 Optical transmission system
10, 20, 30 Operation support system
40 Monitoring network
100, 100A, 200, 300, 400 Optical transmission device
110, 110A, 210 Optical wavelength multiplexing equipment (WME)
101, 401 Optical monitor
111 to 113 Optical channel monitor
114 Multiplexer
120, 120A, 220, 320, 420 Element management system (EMS)
150 Optical fiber transmission path
211, 212 Optical channel monitor
214 Demultiplexer
314 Demultiplexer
350 Fiber pair
351, 352 Fiber
411, 412 Optical channel monitor
414 Multiplexer
900 Optical transmission system
901 Optical transmission device
902 Monitoring network
903, 904 Operation support system
950 Optical fiber transmission path
910 Optical wavelength multiplexing equipment (WME)
911 Multiplexer
912 Optical channel monitor (OCM)
920 Element management system (EMS)

1. An optical transmission device to be used in an optical transmission system in which a band of an optical fiber transmission path constituted of one optical fiber is shared by a plurality of users by using a wavelength multiplexed signal acquired by wavelength-multiplexing a plurality of optical signals, the optical transmission device comprising:
an optical monitor configured to output, for each wavelength associated with and allocated to each of the plurality of users, alarm information related to each of the plurality of optical signals; and
a management circuit configured to transmit the alarm information for each wavelength being output from the optical monitor, to only a user with whom the wavelength is associated.

2. The optical transmission device according to claim 1, wherein the alarm information is notified, based on user information indicating correspondence between wavelengths of the plurality of optical signals and information of the plurality of users, to only a user who uses the wavelength.

3. The optical transmission device according to claim 2, wherein the user information includes:
wavelength information indicating correspondence between wavelengths of the plurality of optical signals and identifiers for identifying the plurality of users; and
address information indicating correspondence between the identifier and a transmission destination of the alarm information for each of the identifiers.

4. The optical transmission device according to claim 3, wherein
the optical monitor outputs the alarm information to the management circuit, based on the wavelength information, and
the management circuit notifies, based on the address information, the alarm information to only a user who uses the wavelength among the plurality of users.

5. The optical transmission device according to claim 4, wherein
the optical monitor includes a plurality of optical channel monitors each of which is associated with the plurality of users on a one-to-one basis, and
the plurality of optical channel monitors output the alarm information of the optical signal having a wavelength allocated to the associated user.

6. The optical transmission device according to claim 2, wherein the management circuit notifies, based on the user information, the alarm information to only a user who uses the wavelength.

7. The optical transmission device according to claim 1, further comprising a multiplexer configured to wavelength-multiplex the plurality of optical signals and output the wavelength-multiplexed optical signals to the optical fiber transmission path, wherein
the optical monitor outputs the alarm information of the plurality of optical signals being output from the multiplexer.

8. The optical transmission device according to claim 1, further comprising a demultiplexer configured to output the plurality of optical signals acquired by wavelength-demultiplexing the plurality of optical signals received from the optical fiber transmission path, wherein
the optical monitor outputs the alarm information of the plurality of optical signals being input to the demultiplexer.

9. An optical transmission system comprising:
an optical transmission device to be used in the optical transmission system in which a band of an optical fiber transmission path constituted of one optical fiber is shared by a plurality of users by using a wavelength multiplexed signal acquired by wavelength-multiplexing a plurality of optical signals, the optical transmission device comprising:
an optical monitor configured to output, for each wavelength associated with and allocated to each of the plurality of users, alarm information related to each of the plurality of optical signals;
a management circuit configured to transmit the alarm information for each wavelength being output from the optical monitor, to only a user with whom the wavelength is associated; and
a multiplexer configured to wavelength-multiplex the plurality of optical signals and output the wavelength-multiplexed optical signals to the optical fiber transmission path, wherein the optical monitor outputs the alarm information of the plurality of optical signals being output from the multiplexer;
the optical fiber transmission path; and
an optical receiver configured to receive the plurality of optical signals received from the optical fiber transmission path.

10. The optical transmission system according to claim 9, further comprising an operation support system configured to be installed for each of the plurality of users and receive the alarm information being output by the management circuit.

11. The optical transmission system according to claim 9, wherein the optical fiber transmission path is any of optical fibers included in one fiber pair.

12. The optical transmission system according to claim 9, wherein the optical receiver is another optical transmission device to be used in an optical transmission system in which a band of an optical fiber transmission path constituted of one optical fiber is shared by a plurality of users by using a wavelength multiplexed signal acquired by wavelength-multiplexing a plurality of optical signals, the another optical transmission device comprising:
an optical monitor configured to output, for each wavelength associated with and allocated to each of the plurality of users, alarm information related to each of the plurality of optical signals;
a management circuit configured to transmit the alarm information for each wavelength being output from the optical monitor, to only a user with whom the wavelength is associated; and
a demultiplexer configured to output the plurality of optical signals acquired by wavelength-demultiplexing the plurality of optical signals received from the optical fiber transmission path, wherein
the optical monitor outputs the alarm information of the plurality of optical signals being input to the demultiplexer.

13. An optical transmission method to be used in an optical transmission system in which a band of an optical fiber transmission path constituted of one optical fiber is shared by a plurality of users by using a wavelength multiplexed signal acquired by wavelength-multiplexing a plurality of optical signals, the method comprising:
outputting, for each wavelength associated with and allocated to each of the plurality of users, alarm information related to each of the plurality of optical signals; and
transmitting the alarm information for each wavelength to only a user with whom the wavelength is associated.

14. The optical transmission method according to claim 13, further comprising notifying, based on user information indicating correspondence between wavelengths of the plurality of optical signals and information of the plurality of users, the alarm information to only a user who uses the wavelength.
